(19) United States
(12) Patent Application Publication
(10) Pub. No.: US 2011/0175827 A1
(43) Pub. Date: Jul. 21, 2011

(54) Filtering Input Streams in a Multi-Touch System

(76) Inventor: Adam Bogue, Framingham, MA (US)

(21) Appl. No.: 12/842,207

(22) Filed: Jul. 23, 2010

Related U.S. Application Data
(63) Continuation-in-part of application No. 12/631,602, filed on Dec. 4, 2009.

(51) Int. Cl. G06F 3/041

(52) U.S. Cl. 345/173

(57) ABSTRACT

Once a first touch has been initiated on a multi-touch input device, the device ignores any additional touches which are initiated on the device while the first touch is still occurring. For example, although hardware in the device may detect such additional touches, the hardware may opt not to provide input representing such additional touches to software (such as device drivers) executing on the device. Alternatively, the hardware may provide input representing such additional touches to software executing on the device, but such software may ignore such input, such as by not associating the input with any touch input streams maintained by the software. In summary, although the device has the inherent ability to process multiple simultaneous touches, the device may be configured to operate in a “first come, first served” mode, in which the device acts only on touches initiated while no other touch is still occurring.

### CROSS-REFERENCE TO RELATED APPLICATIONS

This application is a continuation-in-part of U.S. patent application Ser. No. 12/631,602, filed on Dec. 4, 2009, entitled, “Segmenting a Multi-Touch Input Region by User,” which is hereby incorporated by reference herein.

### BACKGROUND

A multi-touch input device is one which is capable of recognizing two or more simultaneous touches as inputs. One example of a multi-touch input device is a multi-touch screen, which uses a single screen as both a display screen and a multi-touch input device. A multi-touch screen may be used, for example, as an alternative interface to a traditional mouse and keyboard interface to a personal computer. Many existing software applications, however, have been designed to receive input from a mouse and keyboard. Therefore, in order to support popular legacy software applications, multi-touch screens may need to provide for mouse emulation (i.e., a lexicon for translating multi-touch inputs into mouse events).

Large multi-touch screens may provide an opportunity for multiple users to receive output through and provide input through the same display simultaneously. However, unless the multi-touch screen is capable of identifying the users associated with distinct inputs, inputs from one user may be misinterpreted when such inputs are received simultaneously with inputs from other users.

For example, when using a multi-touch screen in connection with a legacy computer operating system that supports only a single cursor (e.g., an on-screen pointer which may be moved in response to input received from a hardware device, such as mouse, or a mouse emulator), as is the case with many personal computer operating systems today, a problem may occur when one user is in mid-touch (e.g., dragging a file into a folder) while a second user touches the screen. In this event, the multi-touch screen may detect the touch from the second user, and the mouse emulator may interpret this touch as a movement of the first user's emulated mouse, which may cause unexpected and undesirable results, such as jumping of the cursor on screen.

Even when using a computer operating system that supports multiple cursors, touches by one user may be misinterpreted in the presence of simultaneous touches by a second user. In this case, it would be desirable for touches by the second user not to interfere with the correct interpretation of touches by the first user, and vice versa.

### SUMMARY

In accordance with one or more embodiments of the invention, once a first touch has been initiated on a multi-touch input device (such as a multi-touch screen, which may combine the functionality of both a touch input device and a display screen, using a display screen which is capable of both receiving touch input and displaying output), the device ignores any additional touches which are initiated on the device while the first touch is still occurring. For example, although hardware in the device may detect such additional touches, the hardware may opt not to provide input representing such additional touches to software (such as device drivers) executing on the device. As another example, the hardware may provide input representing such additional touches to software executing on the device, but such software may ignore such input, such as by opting not to associate the input with any touch input streams maintained by the software. In summary, although the device has the inherent ability to process multiple simultaneous touches, the device may be configured to operate in a “first come, first served” mode, in which the device acts only on touches initiated while no other touch is still occurring.

For example, one embodiment of the present invention is directed to techniques for: (A) receiving a first input associated with a first touch on a touch input surface; (B) processing the first input; (C) receiving a second input associated with a second touch on the touch input surface, wherein the second touch is initiated while the first touch is still occurring; and (D) ignoring the second input.

Another embodiment of the present invention is directed to techniques for: (A) receiving a first input associated with a first touch on a touch input surface; (B) processing the first input; (C) receiving a second input associated with a second touch on the touch input surface; (D) determining whether the second touch was initiated while the first touch was still occurring; (E) ignoring the second input if it is determined that the second touch was initiated while the first touch was still occurring; and (F) processing the second input it is not determined that the second touch was initiated while the first touch was still occurring.

Yet another embodiment of the present invention is directed to techniques for: (A) operating a touch input system in a first mode of operation at a first time, in which the touch input system: (A)(1) associates a first input, representing a first location of a first touch on a touch input surface of the touch input system, with a first input stream; (A)(2) associates a second input, representing a second location of a second touch on the touch input surface, with a second input stream, wherein the second touch overlaps in time with the first touch; and (B) operating the touch input system in a second mode of operation at a first time, in which the touch input system: (B)(1) associates a third input, representing a third location of a third touch on the touch input surface, with a third input stream; and (B)(2) ignores a fourth input, representing a fourth location of a fourth touch on the touch input surface, wherein the fourth touch overlaps in time with the third touch.

Other features and advantages of various aspects and embodiments of the present invention will become apparent from the following description and from the claims.

### BRIEF DESCRIPTION OF THE DRAWINGS

FIG. 1 is a schematic representation of a touch screen system according to an embodiment of the present invention.

FIGS. 2A and 2B are flowcharts of methods of associating touches with different users according to embodiments of the present invention.

FIGS. 3A-4G are schematic representations of a touch screen at various times during the methods of FIGS. 2A and 2B, according to embodiments of the present invention.

FIGS. 5A-C are schematic representations of a touch screen indicating identified regions associated with inputs representing locations of touches, according to embodiments of the present invention.

FIGS. 6A-6B are timing diagrams of the methods of FIGS. 2A and 2B, according to embodiments of the present invention.

FIGS. 7A, 7B, 7C, 7D, 7E, and 8 are flowcharts of methods of filtering simultaneous touches on a touch input surface of a multi-touch device according to embodiments of the present invention.

FIG. 9 is a flowchart of a method of dynamically configuring the touch screen system of FIG. 1 to operate in a first mode according to FIGS. 2A-2B or in a second mode according to FIG. 7 or FIG. 8, according to one embodiment of the present invention.

### DETAILED DESCRIPTION

In some information systems (e.g., geospatial information systems), people may work together on a single computing device at the same time. In such situations, people may be looking at information (e.g., geographic information) and making decisions about that information at the same time as each other.

This may present a problem of how to equip the computing device to distinguish touch inputs received from one user from touch inputs received from another user. Hardware solutions, such as the DiamondTouch multi-user table computer, distinguish one user's touches from another user's touches using the computer's touch input hardware. As a result, two users may, for example, mark up a document at the same time in a way that enables word processing software executing on the computer to track the markups by user.

Such hardware solutions may, however, require specific hardware to distinguish one user's touches from another. In the case of the DiamondTouch system, for example, a custom table and chairs may be required. In this case, when one user touches the table, a circuit is completed between signals that transmit from the touch surface, through the user, and to a receiver attached to the user's chair, thereby enabling the identification of which user is associated with a particular touch. This technique relies on such custom hardware to distinguish the touch of one user from that of another.

Furthermore, there are not currently many software applications which accept input from multiple users simultaneously. For software applications which are designed to accept input from only a single user at a time, a first-come, first-served protocol may be used for processing touch input provided by multiple users. In particular, when the first user touches the touch screen (e.g., by finger, stylus, palm, or other physical item), the cursor may be moved to the position of that touch. If a second user touches the touch screen while the first user is still touching it, the second touch may be ignored. One benefit of this protocol is that it may prevent the touch of the second user from making the first user's cursor jump toward the location of the second user's touch. Such a protocol may, however, still require special hardware to tell the first user from the second. Furthermore, such a protocol does not enable multiple simultaneous touches from multiple users to be recognized and processed; instead, the second user's touch is simply ignored.

As noted above, for a computer operating system that supports only a single cursor, as is the case with the operating systems installed on many PCs today, a problem may occur if one user is in mid-operation (e.g., dragging a file into a folder) when a second user touches the screen. In this case, the touch screen may detect the input from the second user, which the mouse emulator may interpret as an intended movement of the first user's cursor, which may cause unexpected results. Therefore, it would be desirable for the mouse emulator to selectively “ignore” the inputs from the second user and thereby implement a “first-come, first-serve” protocol, but in a hardware-independent manner.

Also as noted above, for a computer operating system that supports multiple cursors, a problem may occur when multi-touch inputs from one user are misinterpreted in the presence of simultaneous touches by a second user. Therefore, it would be desirable for the mouse emulator to separate the touch input streams of one user from the touch input streams of a second user, but in a hardware-independent manner.

In accordance with one or more embodiments of the invention, once a touch has been initiated on a touch input device (such as a multi-touch screen, which may combine the functionality of both a touch input device and a display screen, using a display screen which is capable of both receiving touch input and displaying output), the input coordinate space of the touch input device may be geographically segmented such that any additional touches in close proximity to the initial touch point may be treated differently than any subsequent touches not in close proximity to the initial touch point. Additional touches near the initial touch point may be treated as part of the same input stream as the initial touch. Additional touches that are not near the initial touch point may be treated as part of a second, independent input stream. If the initial touch point moves, as may be the case when a single finger touches and drags across the surface of the touch input device, the area to be treated as “in close proximity” may be relative to the current location of the touch (i.e., the zone of proximity may travel with the finger as the finger moves). When contact of the first user's finger with the touch input device is broken, the proximity zone may be cleared. When a touch is again established, the process may start over at the location of the new touch. With this approach, a “first-come, first-serve” protocol may be established, such as may be used with a mouse emulator. This approach also supports multiple independent touch input streams, such as may be used with a mouse emulator.

One or more embodiments of the present invention may be hardware independent (e.g., may be an algorithm which may work on any type of hardware). One or more embodiments may identify which of a plurality of users is associated with any particular touch on a touch input device. One or more embodiments may enable, for example, legacy systems (e.g., a program using a standard Microsoft Windows user interface) to function with any touch input device, including a multi-touch screen or other multi-touch input device.

As is clear from the above, one problem may be how to distinguish one input stream from another. One or more embodiments of the present invention may solve this problem by defining a region, within the coordinate space of the touch screen, that is associated with (e.g., contains) the initial location of a first touch by a user. The first touch may be associated with (e.g., appended to) a first input stream. If the user then drags his or her finger (i.e., if the initial touch point moves), the region may move with the user's finger as it moves. Any touch which subsequently occurs outside the region may be associated with (e.g., appended to) a second input stream that is distinct from the first input stream associated with the first touch. The second input stream may, for example, be ignored, or the second input stream may be processed as a second input stream. For example, the first input stream may be used by a mouse emulator to control movement of a first cursor, and the second input stream may be used by the mouse emulator to control movement of a second cursor. There may be any number of input streams.

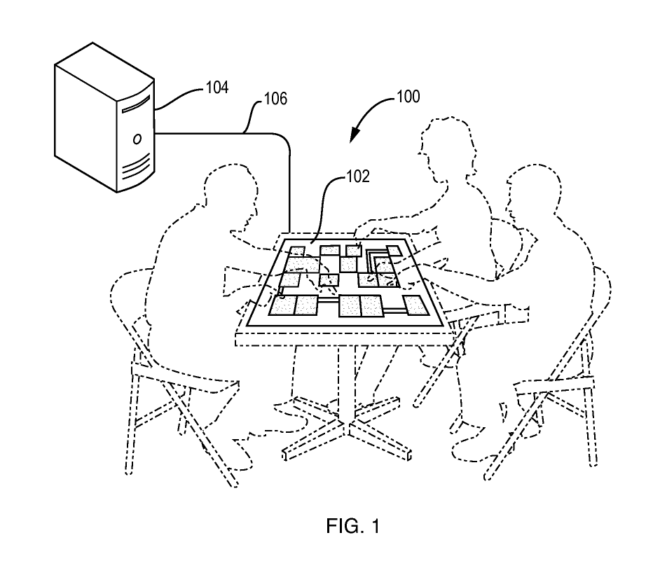

FIG. 1 is a schematic representation of a touch screen system 100 according to an embodiment of the present invention. The touch screen system 100 may include a touch screen 102 connected to a computing device 104 via a connection 106. The connection 106 may include both input and output connections. By way of non-limiting example, the touch screen system 100 may be a large table-sized computer with a touch-screen 102. In this example, the touch screen 102 may be horizontal. Alternatively, the touch screen 102 may be vertical or any other orientation. Multiple users may sit at the table-sized computer, face to face, each working on the table-sized computer.

The touch screen 102 may include an input sensor to determine a physical contact between a user and the touch screen 102. By way of non-limiting examples, the touch screen 102 and sensor may be optically-based (e.g., use one or more cameras), pressure-sensitive, or capacitive. The touch screen 102 may be of any size. For example, its diameter may be less than 2 inches, less than 4 inches, less than 9 inches, less than 15 inches, less than 20 inches, less than 30 inches, or greater than 30 inches. The touch screen 102 may display output in a vertical orientation, a horizontal orientation, or be switchable (manually or automatically) between vertical and horizontal orientations.

In one or more embodiments, physical contact between the user and the touch screen 102 may result in generation of an input to the computing device 104 via the connection 106 representing a location of the physical contact. An input may be any kind of signal generated in response to a physical touch. The signal may be, by way of non-limiting examples, an electrical signal sent from one hardware component to another, a signal received by software from hardware, or a message passed from one piece of software to another. In the example illustrated in FIG. 1, the input may be generated by the touch screen. Alternatively, the input (and other operations and determinations discussed below) may be generated and received, partially or completely, at one or more other levels in the touch-screen system 100 (e.g., by an operating system or other software, such as driver software or application software).

The input may be any appropriate input. By way of non-limiting examples, the input may be for controlling movement of a cursor, emulating a double-click, or representing a “pinching” event. In the case of controlling movement of a cursor, the input may include the coordinates of the location of the physical touch. The physical contact may vary in size (e.g., may vary according to the size and pressure of the user's finger or hand posture). The coordinates contained within the input may be, by way of non-limiting example, at a point that is centered within the location of the physical contact. The input may, for example, be generated substantially in real-time (i.e., with nominal delay) in relation to the physical touch which caused the input to be generated. Alternatively, the input may be delayed and may further include time information indicating a time associated with the input, such as a time at which the corresponding touch occurred.

Examples of inputs include touch down events and touch up events. A touch down event may be generated in response to initiation of the physical touch (e.g., when a user's finger first touches the input surface of the touch input device). The touch up event may be generated in response to completion of the physical touch (e.g., when the user's finger first ceases making contact with the input surface of the touch input device). Another example of an input is a drag event, which may be generated in response to the user moving his finger (or other touch mechanism) on the input surface of the touch input device after a touch down event has occurred and before a touch up event has occurred. Although inputs such as touch down, touch up, and drag events may be used to control the movement of a cursor, they may also be used for other purposes.

The touch screen 102 may include a display device to display a screen image output from the computing device 104 via the connection 106.

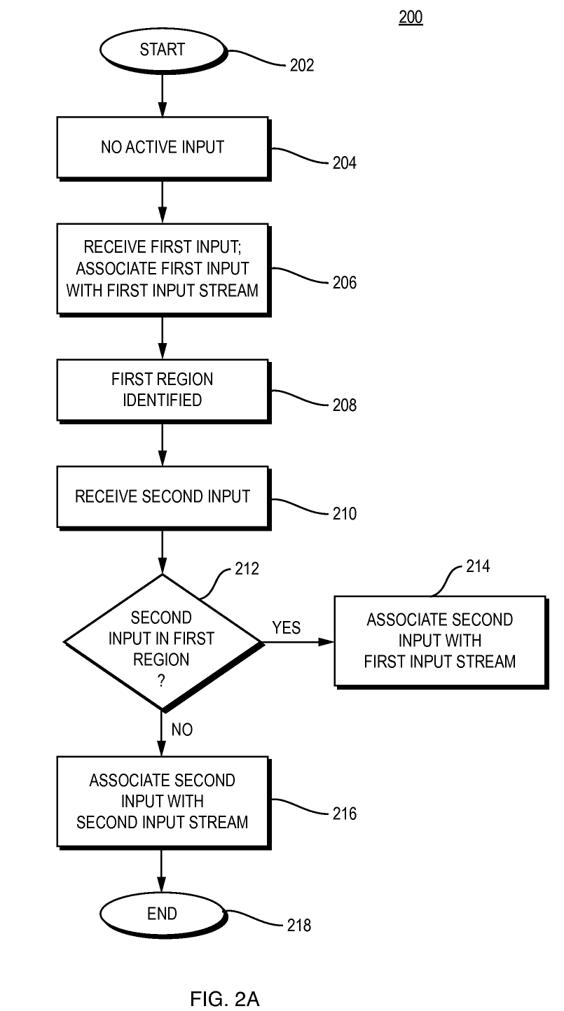

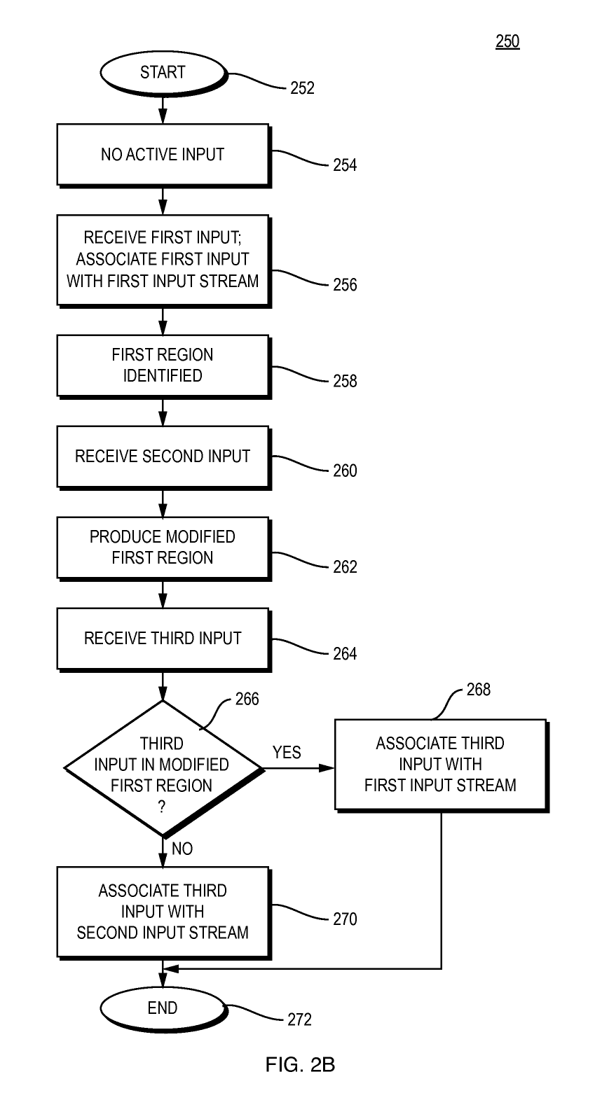

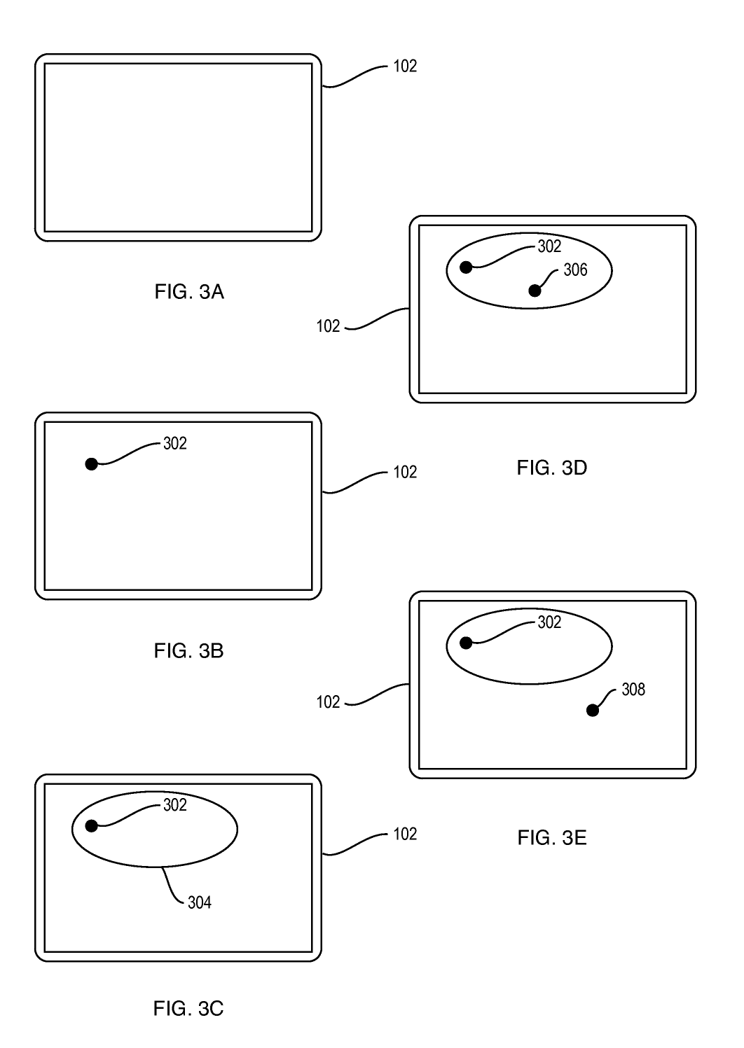

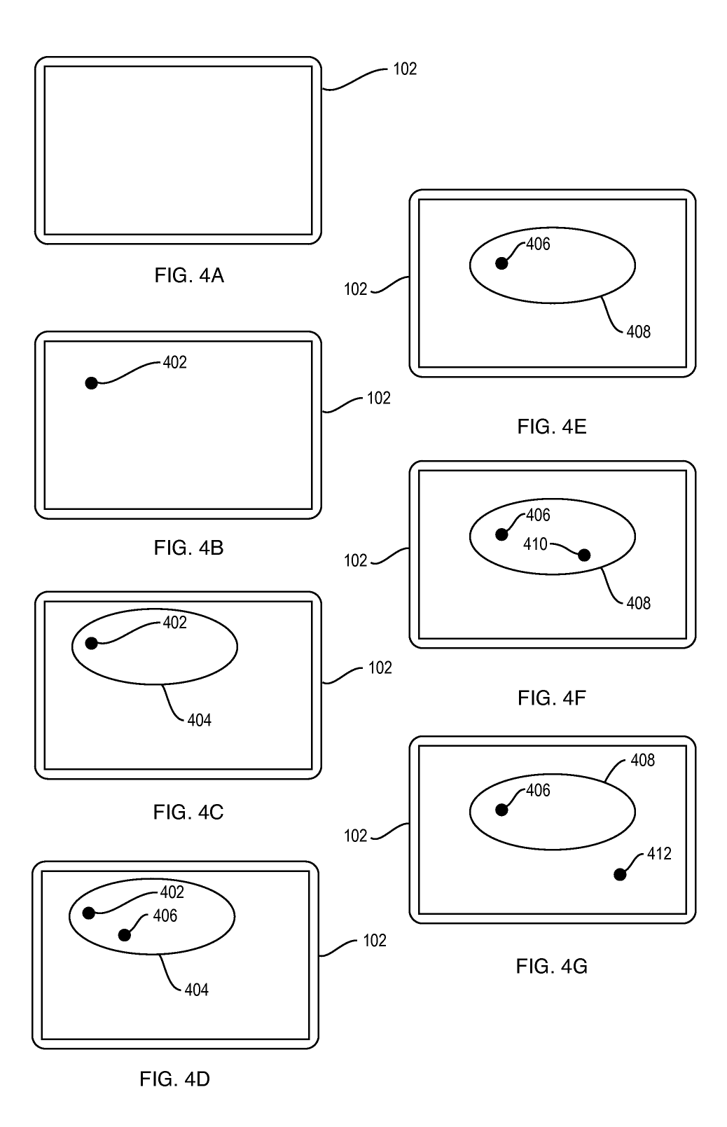

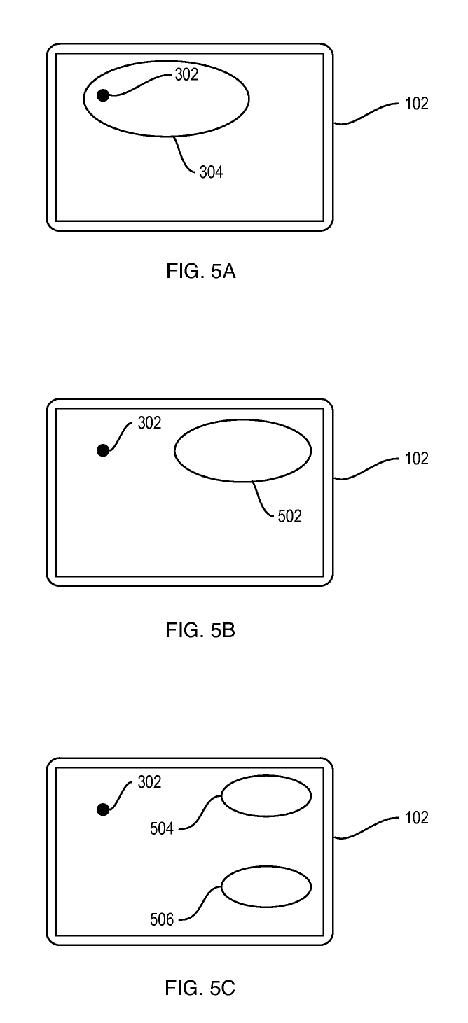

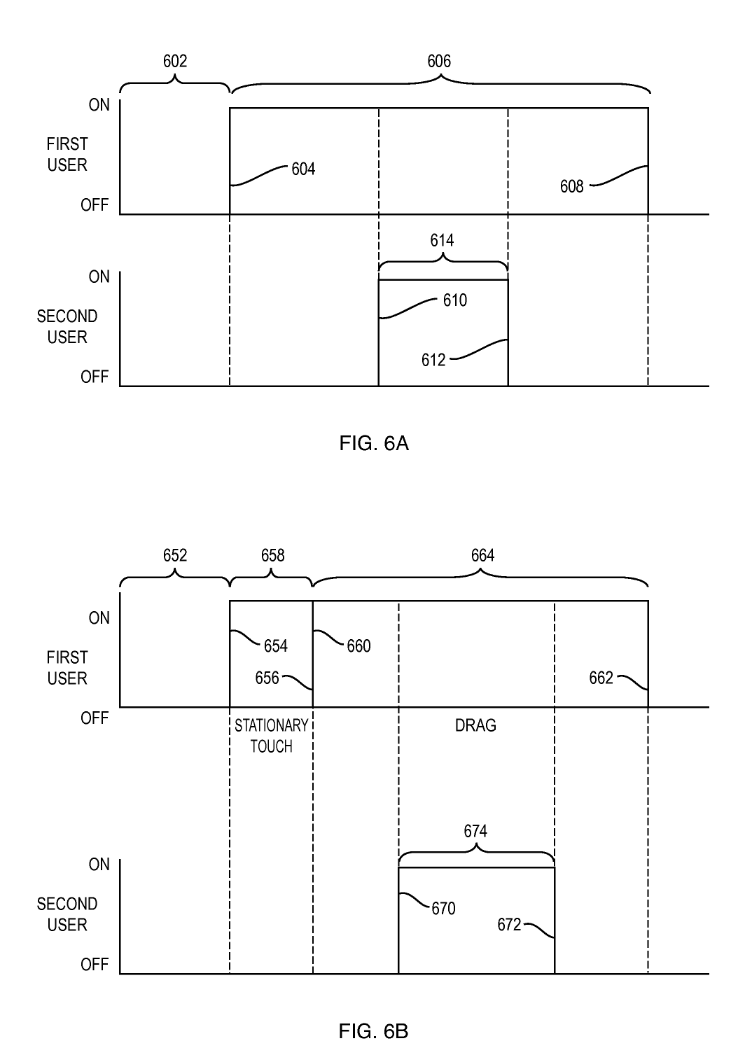

The operation of the touch screen system 100 is now described with reference to FIGS. 2A-6D. FIGS. 2A and 2B are flowcharts of exemplary methods 200, 250 of associating touches with different users according to embodiments of the present invention. FIGS. 3A-4G are schematic representations of touch screen 102 at various times during the methods 200, 250 of associating touches with different users, according to embodiments of the present invention. FIGS. 5A-C are schematic representations of touch screen 102 indicating identified regions associated with inputs representing locations of touches, according to embodiments of the present invention. FIGS. 6A-6B are timing diagrams 600, 650 of exemplary methods 200, 250 of associating touches with different users, according to embodiments of the present invention.

In operation 202, the first method 200 may start. As shown in FIG. 3A, the touch screen 102 may, during operation 204, not be receiving physical contact from a user. Accordingly, no active input may be received by the computing device 104. The period 602 during which no active input is received may last for a time.

As shown in FIG. 3B, the touch screen 102 may, during operation 206, receive a first physical touch by the user. Accordingly, a first input representing a first location 302 of the first physical touch may be received by the computing device 104. The first input representing the first location 302 may have a start time 604 and an end time 608, and may last for a first active input period 606 corresponding to a range of times. Note that although the first input may be represented by a signal which includes information such as the start time 604 and end time 608, this or other timing information associated with the first input need not be stored within such a signal. For example, such timing information may be implicit in the signal and be obtained from another source, such as a system clock, by any component which processes the first input. Furthermore, any timing information associated with the first input may be represented in forms other than a start time and end time.

The first input may be associated with (e.g., appended to) a first input stream. The first input stream may include a first stream of inputs for controlling movement of a first cursor on the touch screen 302. A cursor may be displayed on touch screen 102 at coordinates derived from the first location 302.

As shown in FIG. 3C, the touch screen 102 may, during operation 208, be geographically segmented to include a first region 304 (i.e., first region 304 may be identified). The boundaries of the first region 304 are shown on the touch screen for the sake of clarity of this disclosure. The boundaries of the first region 304 may not, however, be visible to the user. The first region 304 may be associated with the first input representing the first location 302. As shown in FIGS. 3C and 5A, the first region 304 may contain the first location 302. However, as shown in FIG. 5B, a first region 502 may not contain the first location 302. Further, as shown in FIG. 5C, multiple non-contiguous regions 504, 506 may be identified and associated with the first input.

As shown in, for example, FIG. 3C, the first region 304 may be circular. Alternatively, the first region may be, by way of non-limiting examples, elliptical or rectangular. The region 304 may be defined in any way, such as by reference to a set of vectors defining a shape, or by a set of pixels contained within the region 304. The size (area) of the first region 304 may be static or dynamic and may be determined in any manner. By way of non-limiting examples, the size may be fixed predetermined size, a percentage of the total area of the touch screen 102, a size corresponding to that of a typical human hand, or may vary depending on which software application the computing device 104 is running.

As shown in FIG. 3D or 3E, the touch screen 102 may, during operation 210, receive a second physical touch at some point in time after the first physical touch. Accordingly, a second input representing a second location 306 or 308 of the second physical touch may be received by the computing device 104. The second input representing the second location 306 or 308 may have a start time 610 and an end time 612, and may last for a second active input period 614. The second input representing the second location 306 or 308 may be initiated after the start 604 of the first input representing the first location 302. The second active input period 614 may at least partially overlap at least part of the first active input period 606. In other words, the second touch on the touch screen 102 may occur while the first touch on the touch screen 102 is still occurring. Although in the example shown in FIG. 6A the second input end time occurs before the first input end time 612, this is merely an example and does not constitute a limitation of the invention. Rather, for example, the second input end time 612 may occur simultaneously with or after the first input end time 608.

In operation 212, a determination may be made whether the second input representing the second location 306 or 308 is within the first region 304. If a determination is made that the second input representing the second location 306 is within the first region 304 (FIG. 3D), the second input may, in operation 214, be associated with (e.g., appended to) the first input stream. If a determination is made that the second input representing the second location 308 is not within the first region 304 (FIG. 3E), the second input may, in operation 216, be associated with (e.g., appended to) a second input stream. Alternatively, the second input may be ignored (e.g., the second input may never be sent to software). If a determination is made that the second input representing the second location overlaps the boundary of the first region 304, the second input may, in operation 214, be associated with (e.g., appended to) the first input stream. Alternatively, if a determination is made that the second input representing the second location overlaps the boundary of the first region 304, the second input may, in operation 216, be associated with (e.g., appended to) a second input stream.

In operation 218, the first method 200 may end.

In operation 252, the second method 250 may start. As shown in FIG. 4A, the touch screen 102 may, during operation 254, not be receiving physical contact from a user. Accordingly, no active input may be received by the computing device 104. The period 652 during which no active input is received may last for a time.

As shown in FIG. 4B, the touch screen 102 may, during operation 256, receive a first physical touch by the user. Accordingly, a first input representing a first location 402 of the first physical touch may be received by the computing device 104. The first input representing the first location 402 may have a start time 654 and an end time 656, and may last for a first active input period 658. The first input may be associated with (e.g., appended to) a first input stream.

As shown in FIG. 4C, the touch screen 102 may, during operation 258, be geographically segmented to include a first region 404 (i.e., first region 404 may be identified). As noted above, the boundaries of the first region 404 may not be visible to the user. The first region 404 may be associated with the first input representing the first location 402. As shown in FIG. 4C, the first region 404 may contain the first location 402. However, the first region may not contain the first location 402. Further, multiple regions may be identified and associated with the first input. By way of non-limiting examples, the first region may be circular, elliptical, or rectangular. The size of the first region may be static or dynamic.

As shown in FIG. 4D, the touch screen 102 may, during operation 260, receive a second physical touch by the user. Accordingly, a second input representing a second location 406 of the second physical touch may be received by the computing device 104. The second input representing the second location 406 may have a start time 660 and an end time 662, and may last for a second active input period 664.

As shown in FIG. 4E, during operation 262, the first region may modified based on the second input representing the second location 406 to produce a modified first region 408.

As shown in FIG. 4F or 4G, the touch screen 102 may, during operation 264, receive a third physical touch. Accordingly, a third input representing a third location 410 or 412 of the third physical touch may be received by the computing device 104. The third input representing the third location 410 or 412 may have a start time 670 and an end time 672, and may last for a third active input period 674. The third input representing the third location 410 or 412 may be initiated after the start 660 of the second input representing the second location 406. The third active input period 674 may at least partially overlap at least part of the second active input period 664. Alternatively from what is shown in FIG. 6B, the third input end time 672 may occur after the second input end time 662.

In operation 266, a determination may be made whether the third input representing the third location 410 or 412 is within the modified first region 408. If a determination is made that the third input representing the third location 410 is within the modified first region 408 (FIG. 4F), the third input may, in operation 268, be associated with (e.g., appended to) the first input stream. If a determination is made that the third input representing the third location 412 is not within the modified first region 408 (FIG. 4G), the third input may, in operation 270, be associated with (e.g., appended to) a second input stream. Alternatively, the third input may be ignored (e.g., the third input may never be sent to software). If a determination is made that the third input representing the third location overlaps the boundary of the modified first region 408, the third input may, in operation 268, be associated with (e.g., appended to) the first input stream. Alternatively, if a determination is made that the third input representing the third location overlaps the boundary of the modified first region 408, the third input may, in operation 270, be associated with (e.g., appended to) a second input stream.

In operation 272, the second exemplary method 250 may end.

Although certain embodiments disclosed above segment the input coordinate space of the touch screen 102, this is not a requirement of the present invention. Rather, certain embodiments of the present invention may be used to filter multiple simultaneous touches on the touch screen 102 without segmenting the input coordinate space of the touch screen 102. In such embodiments, once a first touch is initiated on the touch screen 102, additional simultaneous touches (i.e., touches initiated on the touch screen 102 while the first touch is still occurring) are filtered and thereby ignored, regardless of the location of the additional simultaneous touches in the coordinate space of the touch screen 102. As a result, such filtering may be performed without using the proximity zone described above and without otherwise taking into account the location of the additional simultaneous touches in the coordinate space of the touch screen 102.

In such embodiments, the touch screen system 100 may be configurable to operate in one of two modes: (1) a multi-touch mode, in which the system 100 processes multiple simultaneous touches by segmenting the coordinate space of the touch screen 102 by user, in any of the manners described above with respect to FIGS. 2A-6B; or (2) a single-touch “first-come, first served” mode, in which once a first touch is initiated on the touch screen 102, additional simultaneous touches initiated on the touch screen 102 while the first touch is still occurring are ignored. The system 100 may be capable of entering and operating in either of these two modes at a particular time in response, for example, to user input specifying a particular one of these two modes. As a result, the user may use the same system 100 in different modes at different times, according to the user's needs and/or preferences at those times.

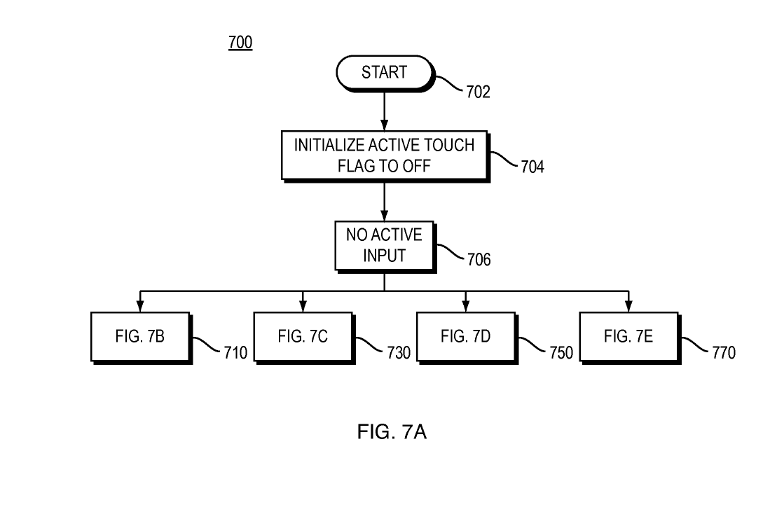

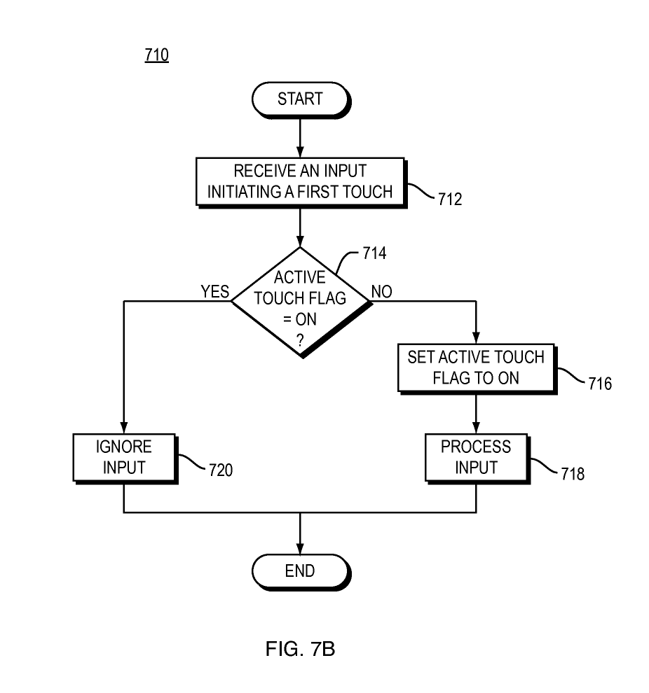

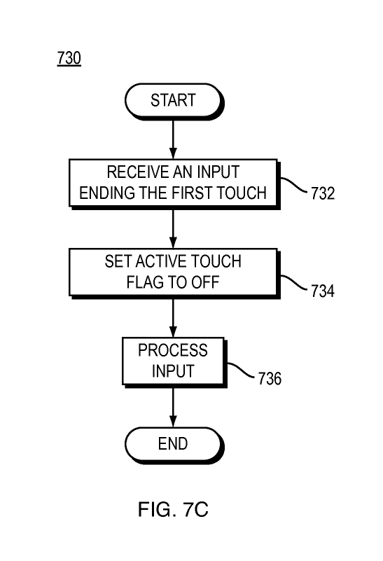

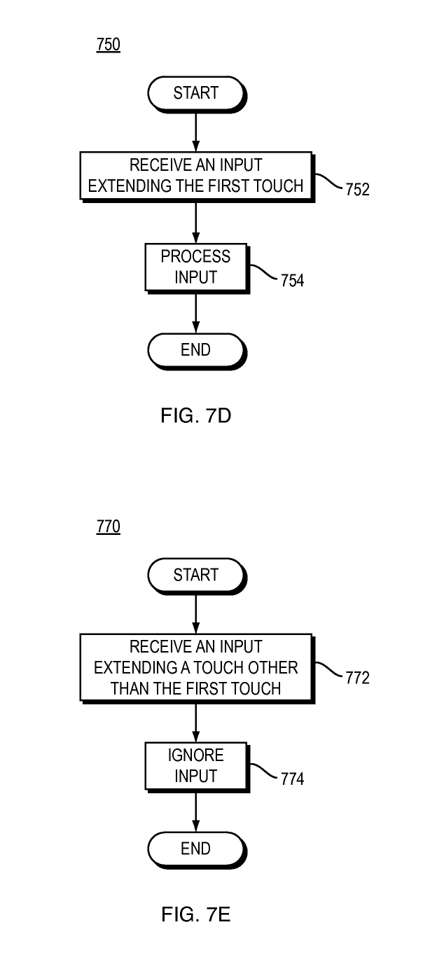

For example, referring to FIG. 7A, a flowchart is shown of an exemplary method 700 of filtering simultaneous touches on a touch input surface of a multi-touch device according to one embodiment of the present invention. This method 700 may, for example, operate in connection with the multi-touch system 100 of FIG. 1. More generally, the method 700 may be performed by or in connection with a system which includes components which are capable of receiving two or more simultaneous touches and which are capable of generating inputs in response to those simultaneous touches.

In operation 702, the first method 700 may start. The method 700 may use an “active touch” flag to keep track of whether a touch is currently active on the touch input surface 102. While a touch is active on the touch input surface 102, the active touch flag is set to a value of ON; while no touch is active on the touch input surface 102, the active touch flag is set to a value of OFF. Therefore, the method 700 begins by initializing the active touch flag to a value of OFF (operation 704).

As shown in FIG. 3A, the touch screen 102 may, during operation 704, not be receiving physical contact from a user. In other words, no touches are active (occurring) on the touch input surface 102 during operation 704. The method 700 then initiates several other methods, namely method 710 (FIG. 7B), method 730 (FIG. 7C), method 750 (FIG. 7D), and method 770 (FIG. 7E), all of which may operate in parallel with each other. For example, each of methods 710, 730, 750, and 770 may be executed in response to corresponding events generated and/or received by the computing device 104, as will be explained in more detail below.

Referring now to FIG. 7B, and as further illustrated in FIG. 3B, the touch screen 102 may, during operation 712, receive a first physical touch by the user. In general, operation 706 may be performed in the same way as operation 206 of method 200 in FIG. 2A. For example, during operation 712, a first input representing a first location 302 of the first physical touch may be received by the computing device 104. This input received in operation 712 represents an initiation of the first touch, and may, for example, be (or trigger the generation of, or be triggered in response to) a touch down event within the computing device 104.

The method 710 determines whether the current value of the active touch flag is ON (operation 714). Recall that the active touch flag was initiated in method 700 of FIG. 7A to a value of OFF, indicating that no touch currently was active on the touch screen 102. If, during operation 714, the value of the active touch flag is still OFF, then method 710 sets the value of the active touch flag to ON (operation 716) and processes the input received in operation 712, such as by associating the input received in operation 712 with a first input stream in any of the ways described above (operation 718).

If instead, during operation 714, the value of the active touch flag is ON, as the result of having previously received an input representing the initiation of a touch which is still occurring (active), then method 710 ignores the input received in operation 712 (operation 720). This is an example of “filtering” the second input, as that term is used herein. Examples of “ignoring” and “filtering” an input include, for example, simply discarding the input, e.g., not associating the input with an input stream maintained by the system 100 in connection with the touch screen 102. As another example, an input may be “ignored” or “filtered” by storing a record of the input, but not taking any action based on the input. For example, if the touch screen 102 currently is being used to control an on-screen mouse cursor, the input may be “filtered” or “ignored” by not using the input to modify the position of the mouse cursor.

In summary, method 710 filters (ignores) additional touches which are initiated on the touch screen 102 while a previous touch is still occurring (active). Note that method 710 does not geographically segment the touch screen 102. Rather, the method 710 filters additional touches which occur during a first (and still active) touch independently of the locations of the additional touches within the coordinate space of the touch screen 102.

As shown in FIG. 7C, an input is received in operation 732 which ends the first touch (i.e., the currently-active touch which previously caused method 710 of FIG. 7B to set the value of the active touch flag to ON in operation 716). Such an input may, for example, be (or trigger the generation of, or be triggered in response to) a touch up event. In response to the input received in operation 732, the method 730 sets the value of the active touch flag to OFF (operation 734), indicating that the first touch is no longer active (occurring), and processes the input received in operation 732, such as by associating the input received in operation 732 with a first input stream in any of the ways described above (operation 736).

As shown in FIG. 7D, an input is received in operation 752 which extends the first touch (i.e., the currently-active touch which previously caused method 710 of FIG. 7B to set the value of the active touch flag to ON in operation 716). Such an input may, for example, be (or trigger the generation of, or be triggered in response to) a drag event associated with the first touch. The method 750 processes the input received in operation 752, such as by associating the input received in operation 742 with a first input stream in any of the ways described above (operation 754).

As shown in FIG. 7E, an input is received in operation 772 which extends a touch other than the first touch. For example, consider a situation in which the user initiates a first touch, and that the first touch is still occurring while the same or another user initiates a second touch and drags the second touch. The drag event associated with such a second touch may be (or trigger the generation of, or be triggered in response to) the input received in operation 772. The method 770 ignores the input received in operation 772 (operation 774), just as the method 710 ignored the input which initiated the second touch (FIG. 7B, operation 720).

In summary, the function performed by the methods illustrated in FIGS. 7A-7E is to process inputs associated with a first touch (such as touch down, drag, and touch up events), but to ignore all inputs associated with touches other than the first touch while the first touch is still occurring (active). This may result in certain components of the system 100 (such as mouse drivers) never receiving inputs associated with additional touches which are initiated while a first touch is still occurring.

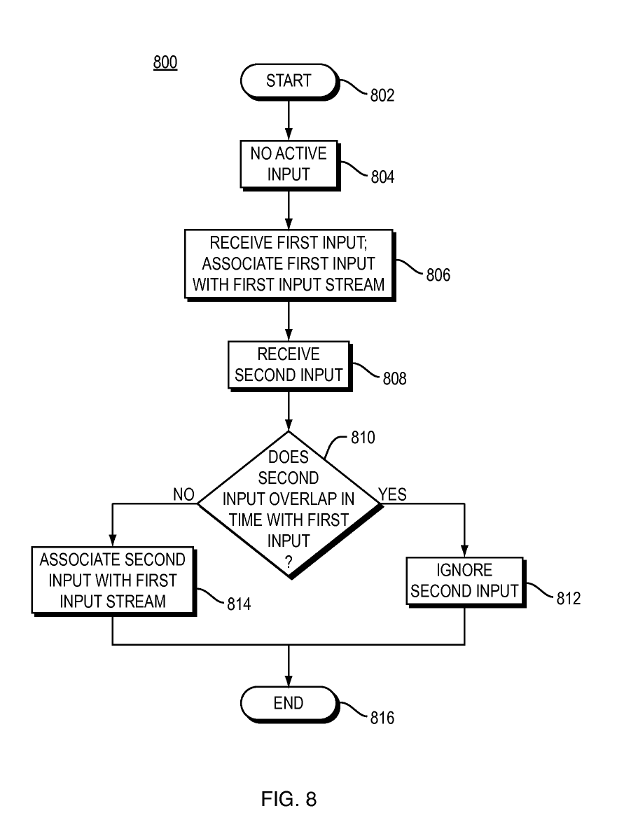

The particular techniques shown in FIGS. 7A-7E are merely one way of performing this function and do not constitute limitations of the present invention. For example, the active status of the first touch may be monitored and/or determined using mechanisms other than the “active touch” flag described above. An example of such an alternative embodiment is illustrated by the method 800 of FIG. 8. In operation 802, the first method 800 may start. As shown in FIG. 3A, the touch screen 102 may, during operation 804, not be receiving physical contact from a user. As shown in FIG. 3B, the touch screen 102 may, during operation 806, receive a first physical touch by the user. In general, operation 706 may be performed in the same way as operation 206 of method 200 in FIG. 2A. For example, during operation 806, a first input representing a first location 302 of the first physical touch may be received by the computing device 104, and the first input may be associated with (e.g., appended to) a first input stream.

As shown in FIG. 3D or 3E, the touch screen 102 may, during operation 808, receive a second physical touch at some point in time after the first physical touch. In general, operation 808 may be performed in the same way as operation 210 of method 200 in FIG. 2A. For example, during operation 808, a second input representing a second location 306 or 308 of the second physical touch may be received by the computing device 104.

The method 800 determines, in operation 810, whether the second input overlaps in time with the first input (i.e., whether the second touch occurs while the first input is still occurring). The method 800 may make this determination, for example, using the start and end times of the first and second inputs, such as the first input start and end times 604 and 608, and the second input start and end times 610 and 612 shown in FIG. 6A. Note that this determination may be made independently of the locations of the first and second touches. Note further that this determination may be made with or without the use of the “active touch” flag used in the methods of FIGS. 7A-7E.

If a determination is made that the second input overlaps in time with the first input, then in operation 812 the method 800 ignores the second input in any of the ways described above.

If a determination is made that the second input does not overlap in time with the first input, then in operation 814 the method 800 associates the second input with the first input stream, in the same manner as operation 214 of FIG. 2A. In response, the system 100 may process the second input in the same way as any other input associated with the first input stream. For example, if the first input stream is an input stream to a mouse driver, then the second input may be used to modify the position of an on-screen mouse pointer.

In operation 816, the first method 800 may end.

Each of operations 806, 808, 810, 812, and 814 may be performed by any component of the system 100. For example, touch-screen hardware may receive the second touch and determine whether the second touch overlaps in time with the first touch. Based on this determination, the touch-screen hardware may decide whether or not to provide a second input to software (e.g., mouse driver software) executing in the system 100. As another example, the touch-screen hardware may provide the second input to software in the system 100 whether or not the second input overlaps in time with the first input, and the software may then determine whether the second input overlaps in time with the first input, and then perform one of operations 812 or 814 accordingly.

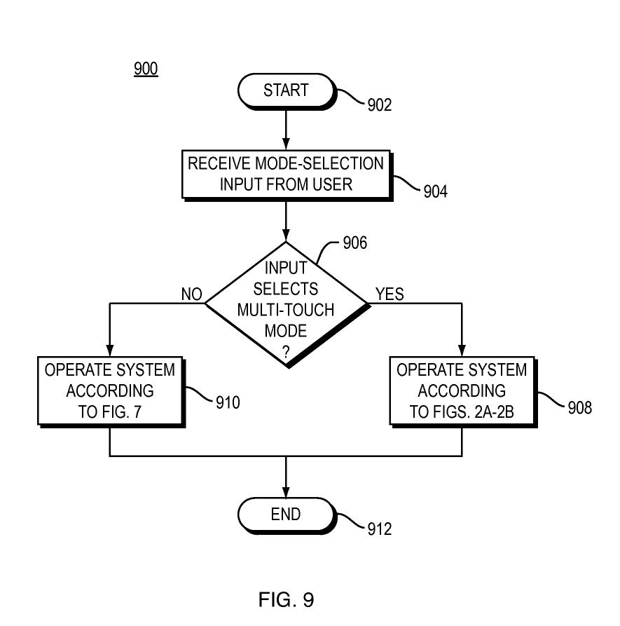

The system 100 may, for example, be configured solely to behave as shown in FIGS. 2A and 2B, or solely to behave as shown in FIGS. 7A-7E or FIG. 8. Alternatively, for example, the system 100 may be dynamically configurable to operate in either of a first mode, in which the system 100 behaves as shown in FIGS. 2A and 2B, and a second mode, in which the system 100 behaves as shown in FIGS. 7A-7E (or FIG. 8). Such an embodiment is illustrated by the method 900 of FIG. 9.

In operation 902, the method 900 may start. In operation 904, the method 900 receives an input from a user, selecting a touch input mode in which the system 100 should operate. Permissible modes may include, for example: (1) a multi-touch mode, in which the system 100 processes touches using the methods 200 and 250 of FIGS. 2A and 2B, respectively; and (2) a single-touch mode, in which the system 100 processes touches using the method 700 of FIG. 7 (or, alternatively for example, using the method 800 of FIG. 8). The user may provide the mode-selection input in any manner, such as by checking a box in a software control panel provided by the system 100. The system 100 may provide unlimited access to such a control panel, or may limit access to the manufacturer of the system 100 or to administrators of the system 100.

In operation 906, the method 900 determines whether the user has selected the multi-touch mode. If the user has selected the multi-touch mode, then in operation 908 the system 100 proceeds to operate according to the methods 200 and 250 of FIGS. 2A and 2B, respectively. If the user has selected the single-touch mode, then in operation 810 the system 100 proceeds to operate according to the method 700 of FIG. 7 (or, alternatively for example, using the method 800 of FIG. 8). If at any subsequent time the user provides another mode-selection input (which may differ from the original mode-selection input), the system 100 may again perform method 900 in response to such input. In this way, the user may cause the system 100 to switch from one touch input node to another at different times, without modifying the hardware or any other component of the system 100.

Embodiments of the present invention have a variety of advantages. For example, embodiments of the present invention enable touches of a first user on a multi-touch device (such as a multi-touch screen) to be distinguished from touches of another user in a manner that is hardware-independent. Touches from the first user may be associated with a first input stream, while touches from the second user may be ignored. This may enable legacy operating systems and other software which only support a single cursor (or which otherwise support only a single user input stream) to function properly when used in connection with a multi-touch screen which is touched by multiple users simultaneously.

Alternatively, for example, touches from the second user may be associated with a second input stream. The ability to associate touches from the first and second user with corresponding first and second input streams may be used, for example, to enable a mouse emulator to support multiple mouse pointers associated with multiple users who use a multi-touch screen simultaneously, in a manner that is hardware independent.

The various features disclosed herein may be provided, for example, using driver software, and may therefore be provided without requiring costly and time-consuming modifications to be made to existing operating systems or applications.

Embodiments of the invention, such as those disclosed in connection with FIGS. 7 and 8, which enable a multi-touch system to operate as a single-touch system, have a variety of advantages. For example, such embodiments have advantages over conventional single-touch systems, because the techniques disclosed in connection with FIGS. 7 and 8 enable a single touch stream to be processed accurately, without the undesirable side-effects often introduced by conventional single-touch systems in response to simultaneous touches. For example, as described above, in conventional single-touch systems, a problem may occur when one user is in mid-touch (e.g., dragging a file into a folder) while a second user touches the screen. In particular, this may cause the on-screen mouse pointer to (incorrectly and undesirably) jump from its current location to the location of the second touch, or even to some third location. The techniques disclosed in connection with FIGS. 7 and 8, in contrast, avoid all such side-effects by actively ignoring the second touch. In effect, the methods 700 and 800 of FIGS. 7 and 8, respectively, use the multi-touch capabilities of the touch input system 100 to provide a better single-touch system than those which currently exist.

Furthermore, the techniques disclosed above in connection with FIG. 9 enable the system 100 to be dynamically and selectively operated in either a multi-touch mode or a single-touch mode. As a result, the users of the system 100 do not need to be locked into using the system 100 in either a multi-touch mode or a single-touch mode. Instead, the users of the system 100 may control which of these two (or other) modes to use at any point in time, according to the users' varying needs at different times. For example, at one time the owner of the system 100 may desire to collaborate with other users and may therefore place the system 100 into a multi-touch mode of operation at that time. At another time, the owner of the system 100 may desire to use the system 100 by himself and may therefore place the system 100 into a single-touch mode of operation at that time. As a result, the system 100 will then ignore any touches initiated by other users on the touch screen 102. Furthermore, the system 100 will also ignore simultaneous touches by the owner himself, such as inadvertent touches by the owner's other fingers, hand, elbow, etc. The ability to enable the user to switch the system 100 between different modes of touch input provides the user with maximum flexibility in using the system 100.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Although certain embodiments of the present invention have been described with respect to a mouse emulator, mouse emulation is only one application of embodiments of the present invention. As is clear from the description above, embodiments of the present invention may be used to segment the input coordinates of a touch input device to identify inputs from multiple users for purposes other than mouse emulation.

Although certain embodiments of the present invention are described in connection with a touch screen, this is merely an example and does not constitute a limitation of the present invention. Rather, embodiments of the present invention may be used in connection with any touch input device, such as a touch pad, whether or not such a device has a display screen or other mechanism for providing output to a user.

Embodiments of the present invention may be performed by any of a variety of mechanisms. In general, any component, such as any hardware or software, which receives a touch screen “input” as that term is used herein, and which processes such an input, is an example of a “touch screen input processing component” as that term is used herein. A mouse driver is one example of a touch screen input processing component. A touch screen input processing component may, for example, perform operations such as defining the region associated with a first touch input and determining whether the location of a second touch is within the defined region.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) receiving a first input associated with a first touch on a touch input surface;
(B) processing the first input;
(C) receiving a second input associated with a second touch on the touch input surface, wherein the second touch is initiated while the first touch is still occurring; and
(D) ignoring the second input.

2. The method of claim 1, wherein the first input represents an initiation of the first touch on the touch input surface.

3. The method of claim 1, wherein the first input represents a drag of the first touch on the touch input surface.

4. The method of claim 1, wherein the second input represents an initiation of the second touch on the touch input surface.

5. The method of claim 1, wherein the second input represents a drag of the first touch on the touch input surface.

6. The method of claim 1, wherein (D) comprises ignoring the second input in response to determining that the second touch was initiated while the first touch was is still occurring.

7. The method of claim 6, wherein the first input is associated with a first range of times of the first touch, wherein the second input is associated with a second range of times of the second touch, and wherein (D) comprises ignoring the second input in response to determining that the second range of times overlaps with the first range of times.

8. The method of claim 1, wherein (B) comprises associating the first input with a first input stream.

9. The method of claim 8, wherein ignoring the second input comprises not associating the second input with the first input stream.

10. The method of claim 8, wherein ignoring the second input comprises not associating the second input with any input stream maintained in connection with the touch input surface.

11. The method of claim 8, wherein the first input stream comprises a first stream of inputs for controlling movement of a first cursor on the touch screen, and wherein ignoring the second input comprises not modifying a position of the cursor in response to the second input.

12. The method of claim 11, wherein the touch screen comprises an optically-based touch screen.

13. The method of claim 1, wherein the touch input surface comprises a touch screen.

14. The method of claim 1, further comprising:
(E) receiving a third input associated with a third touch on the touch input surface, wherein the second touch is initiated after the first touch has terminated; and
(F) processing the third input.

15. The method of claim 14, wherein (B) comprises associating the first input with a first input stream, and wherein (F) comprises associating the third input with the first input stream.

16. The method of claim 1, further comprising:
(E) before (A), receiving the first touch on the touch input surface; and
(F) generating the first input in response to receiving the first touch.

17. A computer-readable medium tangibly storing computer-readable instructions, wherein the computer-readable instructions are executable by a computer processor to cause the processor to perform a method comprising:
(A) receiving a first input associated with a first touch on a touch input surface;
(B) processing the first input;
(C) receiving a second input associated with a second touch on the touch input surface, wherein the second touch is initiated while the first touch is still occurring; and
(D) ignoring the second input.

18. The computer-readable medium of claim 17, wherein the first input represents an initiation of the first touch on the touch input surface.

19. The computer-readable medium of claim 17, wherein the first input represents a drag of the first touch on the touch input surface.

20. The computer-readable medium of claim 17, wherein the second input represents an initiation of the second touch on the touch input surface.

21. The computer-readable medium of claim 17, wherein the second input represents a drag of the first touch on the touch input surface.

22. The computer-readable medium of claim 1, wherein (D) comprises ignoring the second input in response to determining that the second touch was initiated while the first touch was is still occurring.

23. The computer-readable medium of claim 22, wherein the first input is associated with a first range of times of the first touch, wherein the second input is associated with a second range of times of the second touch, and wherein (D) comprises ignoring the second input in response to determining that the second range of times overlaps with the first range of times.

24. The computer-readable medium of claim 17, wherein (B) comprises associating the first input with a first input stream.

25. The computer-readable medium of claim 24, wherein ignoring the second input comprises not associating the second input with the first input stream.

26. The computer-readable medium of claim 24, wherein ignoring the second input comprises not associating the second input with any input stream maintained in connection with the touch input surface.

27. The computer-readable medium of claim 24, wherein the first input stream comprises a first stream of inputs for controlling movement of a first cursor on the touch screen, and wherein ignoring the second input comprises not modifying a position of the cursor in response to the second input.

28. The computer-readable medium of claim 27, wherein the touch screen comprises an optically-based touch screen.

29. The computer-readable medium of claim 17, wherein the touch input surface comprises a touch screen.

30. The computer-readable medium of claim 17, wherein the method further comprises:
(E) receiving a third input associated with a third touch on the touch input surface, wherein the second touch is initiated after the first touch has terminated; and
(F) processing the third input.

31. The computer-readable medium of claim 30, wherein (B) comprises associating the first input with a first input stream, and wherein (F) comprises associating the third input with the first input stream.

32. The computer-readable medium of claim 17, wherein the method further comprises:
(E) before (A), receiving the first touch on the touch input surface; and
(F) generating the first input in response to receiving the first touch.

33. A computer-implemented method comprising:
(A) receiving a first input associated with a first touch on a touch input surface;
(B) processing the first input;
(C) receiving a second input associated with a second touch on the touch input surface;
(D) determining whether the second touch was initiated while the first touch was still occurring;
(E) ignoring the second input if it is determined that the second touch was initiated while the first touch was still occurring; and
(F) processing the second input it is not determined that the second touch was initiated while the first touch was still occurring.

34. The method of claim 33, wherein (B) comprises associating the first input with a first input stream.

35. The method of claim 34, wherein (F) comprises associating the second input with the first input stream.

36. A computer-readable medium tangibly storing computer-readable instructions, wherein the computer-readable instructions are executable by a computer processor to cause the processor to perform a method comprising:
(A) receiving a first input associated with a first touch on a touch input surface;
(B) processing the first input;
(C) receiving a second input associated with a second touch on the touch input surface;
(D) determining whether the second touch was initiated while the first touch was still occurring;
(E) ignoring the second input if it is determined that the second touch was initiated while the first touch was still occurring; and
(F) processing the second input it is not determined that the second touch was initiated while the first touch was still occurring.

37. The computer-readable medium of claim 36, wherein (B) comprises associating the first input with a first input stream.

38. The computer-readable medium of claim 37, wherein (F) comprises associating the second input with the first input stream.

39. A computer-implemented method comprising:
(A) operating a touch input system in a first mode of operation at a first time, in which the touch input system:
associates a first input, representing a first location of a first touch on a touch input surface of the touch input system, with a first input stream;
associates a second input, representing a second location of a second touch on the touch input surface, with a second input stream, wherein the second touch overlaps in time with the first touch; and
(B) operating the touch input system in a second mode of operation at a first time, in which the touch input system:
associates a third input, representing a third location of a third touch on the touch input surface, with a third input stream; and
ignores a fourth input, representing a fourth location of a fourth touch on the touch input surface, wherein the fourth touch overlaps in time with the third touch.

40. The method of claim 39, further comprising:
(C) receiving a mode-selection input from a user selecting one of the first and second modes of operation; and
(D) in response to the mode-selection input, operating the touch input system in the selected one of the first and second modes of operation.

41. A computer-readable medium tangibly storing computer-readable instructions, wherein the computer-readable instructions are executable by a computer processor to cause the processor to perform a method comprising:
(A) operating a touch input system in a first mode of operation at a first time, in which the touch input system:
associates a first input, representing a first location of a first touch on a touch input surface of the touch input system, with a first input stream;
associates a second input, representing a second location of a second touch on the touch input surface, with a second input stream, wherein the second touch overlaps in time with the first touch; and
(B) operating the touch input system in a second mode of operation at a first time, in which the touch input system:
associates a third input, representing a third location of a third touch on the touch input surface, with a third input stream; and
ignores a fourth input, representing a fourth location of a fourth touch on the touch input surface, wherein the fourth touch overlaps in time with the third touch.

42. The computer-readable medium of claim 41, further comprising:
(C) receiving a mode-selection input from a user selecting one of the first and second modes of operation; and
(D) in response to the mode-selection input, operating the touch input system in the selected one of the first and second modes of operation.
